(19) United States
(12) Patent Application Publication
(10) Pub. No.: US 2008/0134089 A1
(43) Pub. Date: Jun. 5, 2008

(54) COMPUTER-ASSISTED WEB SERVICES ACCESS APPLICATION PROGRAM GENERATION

(76) Inventors: Hisatoshi Adachi, Tokyo (JP); Masao Hara, Yamato (JP); Motoharu Inoue, Tsuzuki (JP); Keisuke Nitta, Yamato-Shi (JP)

Correspondence Address: IBM AUSTIN IPLAW (DG), C/O DELIZIO GILLIAM, PLLC, 15201 MASON ROAD, SUITE 1000-312, CYPRESS, TX, 77433, US

(21) Appl. No.: 11/942,870

(22) Filed: Nov. 20, 2007

(30) Foreign Application Priority Data
Dec. 1, 2006 (JP) 2006-326338

(51) Int. Cl. G06F 3/048

(52) U.S. Cl. 715/810

(57) ABSTRACT

A computer-assisted application program creating system comprises a web service display unit, a service model display unit, an application editing unit, and a data hub. The web service display unit is configured to display a list of indicators of web services. The service model display unit is configured to display input, trigger, and output elements of a web service represented by an indicator in the list of indicators of web services. The application editing unit is configured to associate input, output and trigger elements of different web services represented by indicators in the list of indicators of web services. The data hub is configured to display output of a first output element that corresponds to a first of the different web services and configured to apply a function to the output.

### CROSS-REFERENCE TO RELATED APPLICATIONS

This application claims the benefit of priority, under 35 U.S.C. §119(a), of Japanese Patent Application No. 2006-326338 filed on Dec. 1, 2006, and entitled “COMPUTER-ASSISTED APPLICATION PROGRAM CREATING SYSTEM, METHOD, AND PROGRAM PRODUCT,” which is incorporated by reference herein.

### FIELD

Embodiments of the inventive subject matter generally relate to the field of computers, and more particularly, to using a graphical user interface to create an application program.

### BACKGROUND

At the outset of development, a machine language program describes a command to be directly interpreted by the CPU and directly addresses memory. However, it is impossible to visually identify operations written to such programs. Thus, it is difficult to correct bugs in a program or add a new function.

To overcome this drawback, an assembly language has been developed, which enables indirect addressing of a memory by use of a mnemonic that is easy for a user to understand, such as ADD. The program written in this way is translated into a machine language understandable by the CPU. However, even arithmetic logic for describing simple addition uses a register where the CPU references a value in that register, so a program could still have to be developed by a highly skilled programmer.

The emergence of a compiler language developed in the 1950s markedly improved this difficult situation. If this language is used, for example, the addition can be described using a general expression like A=B+C. Input/Output (I/O) processing can be described in an easy-to-understand form by use of a function such as WRITE. Such programming languages are called procedural languages, such as C, C++, and C#, and have been developed to incorporate various ideas.

When such procedural languages appeared, data to be displayed on a screen or printed were character strings like ABC or 1123. However, programming faced another challenge due to development of a graphic user interface (GUI) equipped with a pointing device such as a mouse or a multi-window system in the 1980s. It is now necessary to program the GUI to designate position coordinates where GUI components such as a button, a radio button, a component box, and a text box are displayed on a window. Additionally, GUI programming designates font and color of characters to be displayed, designs pull-down menus, and responds to events in real time, such as a mouse-click on GUI components or switchovers between active windows and inactive windows. In the early stages of GUI programming, these components were described in source code and thus, it was difficult to adapt to new concepts for built-in resources, event-driven programs, and the like. A programmer skilled in the procedural programming language of C or C++ would even have difficulty in mastering it.

To overcome such a problem, program development tools that enable descriptions of predetermined portions of a program through GUI operations, such as mouse-clicking or dragging, have been developed. Examples of these tools include Microsoft Visual Basic®, Visual C++®, Borland Delphi™, C++ Builder™, and IBM VisualAge of Java™. These program development tools can be used to appropriately arrange the GUI components by dragging and dropping the components from a region where sample icons of the GUI components are arranged to a desired position. Furthermore, two GUI components can be associated by appropriately operating a mouse.

The aforementioned development tools make it possible to arrange and associate the GUI components. However, a programmer needs to describe a code or application programming interface (API) function for actual processing on the basis of programming language rules, such as C++, BASIC, or Java. This is difficult for a beginner unaccustomed to computer operations.

In recent years, a concept of communications between applications, called service oriented architecture (SOA) or web service, has been proposed. According to SOA, a GUI based development tool includes a GUI component capable of designating a uniform resource locator (URL) is provided. If access to a specific URL is made by use of a function of the GUI component, a web site designated by the URL sends back information described in Extensible Markup Language (XML), for example. The development tool further prepares a display GUI component for displaying the information described in XML in tree form. Hence, the GUI component accessing the URL and the display GUI component are pasted to a predetermined region of an application program to thereby realize a web application capable of automatically displaying the information sent back from the specific web site.

In the above web application, it is conceivable that an inquiry is directed to a first web service, plural responses are sent back, and the sent data is computed, after which an inquiry is sent to a second web service on the basis of the computation result. For example, if a zip code is sent to a first web service, the first web service sends back a state name and a city name independently. On the other hand, if receiving a character string that combines the state name and the city name, the second web service sends back the longitude and latitude thereof. As is apparent from the above, a program deriving a state name and city name from an entered zip code can be obtained by pasting the GUI components, and an appropriate inquiry cannot be sent to the second web service. To obtain a program capable of sending an appropriate inquiry to the second web service, a character string of the state name and a character string of the city name are combined, and a procedure of supplying the combined data to a GUI component that sends an inquiry to the second web service will be described in a program code. However, describing such a code is much more complicated than one might think because it is necessary to authenticate an ID of the GUI component, describe an operator for combining the character strings, and describe a code for associating the computation result with a GUI component that sends an inquiry to the second web service. This operation is much more complicated than one might think, requires experience, and is very difficult for a beginner.

### SUMMARY

A computer-assisted application program creating system comprises a web service display unit, a service model display unit, an application editing unit, and a data hub. The web service display unit is configured to display a list of indicators of web services. The service model display unit is configured to display input, trigger, and output elements of a web service represented by an indicator in the list of indicators of web services. The application editing unit is configured to associate input, output and trigger elements of different web services represented by indicators in the list of indicators of web services. The data hub is configured to display output of a first output element that corresponds to a first of the different web services and configured to apply a function to the output.

### BRIEF DESCRIPTION OF THE DRAWINGS

The present embodiments may be better understood, and numerous objects, features, and advantages made apparent to those skilled in the art by referencing the accompanying drawings.

FIG. 1 depicts a block diagram illustrating the hardware configuration in an embodiment.

FIG. 2 depicts a block diagram illustrating the hardware configuration in an embodiment.

FIG. 3 depicts a block diagram of a server computer according to some embodiments.

FIG. 4 illustrates an example of an application management environment and a corresponding display screen in an embodiment.

FIG. 5 illustrates an example of a client development environment and a corresponding display screen in an embodiment.

FIG. 6 illustrates an example of a service list display unit according to an embodiment.

FIG. 7 illustrates an example of a service model display unit according to an embodiment.

FIG. 8 illustrates an example of a data hub according to an embodiment.

FIG. 9 illustrates an example of a data hub associating inquires to plural services according to an embodiment.

FIG. 10 depicts a block diagram illustrating a client execution environment in an embodiment.

FIG. 11 depicts a block diagram illustrating service call management environments according to an embodiment.

FIG. 12 depicts a flowchart illustrating an application development scenario according to some embodiments.

FIG. 13 depicts a flowchart illustrating a service call registration in an embodiment.

FIG. 14 through FIG. 23 illustrate examples of application development screens according to some embodiments.

FIG. 24 illustrates an example of the operation of a created application in an embodiment.

FIG. 25 illustrates an example of the operation of a created application in an embodiment.

FIG. 26 through FIG. 29 illustrate an example of an application development screen according to an embodiment.

### DESCRIPTION OF EMBODIMENT(S)

The description that follows includes exemplary systems, methods, techniques, instruction sequences and computer program products that embody techniques of the described embodiments. However, it is understood that the described embodiments may be practiced without these specific details. For instance, although examples refer to modules written in JavaScript, embodiments can be accomplished in other programming languages. In addition, the description refers to the Ethernet protocol, but other communications protocols can be used with various embodiments. In other instances, well-known instruction instances, protocols, structures and techniques have not been shown in detail in order not to obfuscate the description.

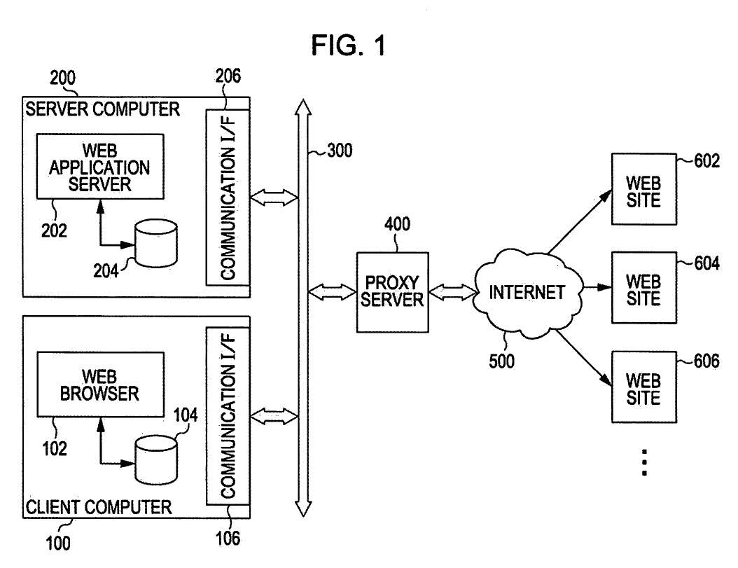

FIG. 1 is a schematic block diagram of a hardware component according to an embodiment. In FIG. 1, a client computer 100 and a server computer 200 are connected to a communication line 300 (e.g. an Ethernet protocol). A server 400 then connects the communication line 300 to an internet 500 through the proxy server 400 to allow access to various web sites, such as web sites 602, 604, and 606, through the internet 500.

The client computer 100 includes a hard disk 104, and a communication interface 106 conforming to the Ethernet protocol. The hard disk 104 stores various programs used in embodiments, such as an operating system or a Web browser 102. The Web browser 102 may be any Web browser that can execute JavaScript; for example, Microsoft Internet Explorer®, Mozilla Foundation FireFox®, Apple Computer Safari®. In addition, any operating system can be used that support a TCP/IP communication function as a standard feature and can execute the Web browser 102. Examples of operating systems include Linux®, Microsoft Windows XP®, Windows® 2000, and Apple Computer Mac OS®, and the like can be used, but the operating system is not limited to these.

The server computer 200 includes a hard disk 204 and a communication interface 206 conforming to an Ethernet protocol. The hard disk 204 stores various programs used in embodiments, such as an operating system, a web browser, and a Web application server 202. The Web application server 202 is a program that can store a Hypertext Markup Language (HTML) document or image and transmit information about the HTML document or image through a network, such as the World Wide Web, in response to a request from a client application, such as a Web browser. The Web application server 202 can implement various server applications (e.g., Apache TomCat, Microsoft Internet Information Server, etc.). For an operating system on the server computer 200, any operating system that supports transmission control protocol/internet protocol (TCP/IP) can be used. Examples of operating systems include Linux®, Microsoft Windows XP®, Windows® 2000, and Apple Computer Mac OS®.

In FIG. 1, the client computer 100 and the server computer 200 are provided inside a firewall, but the server computer 200 can be provided outside the firewall. In this case, if there is a fear about security, the security level can be improved with security mechanisms, such as a virtual private network (VPN).

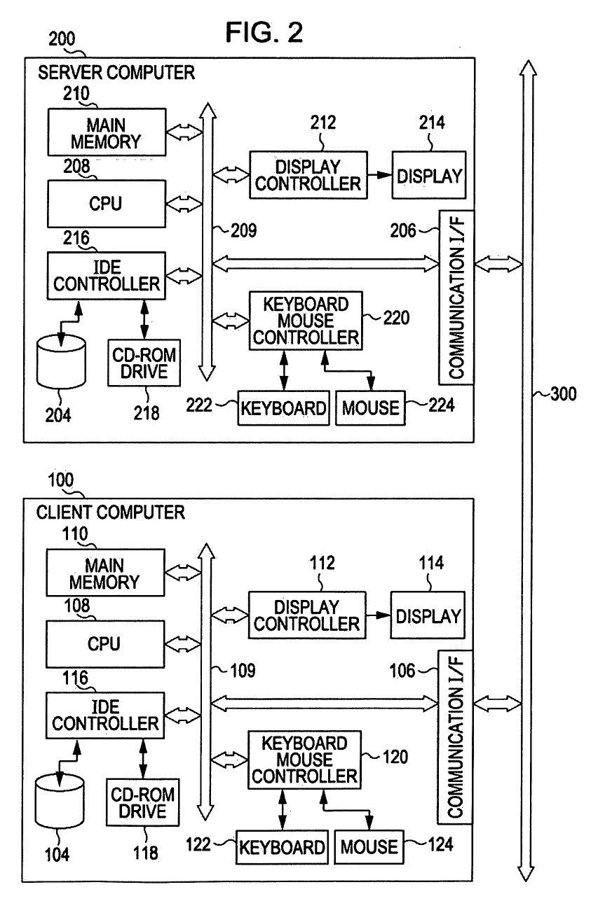

FIG. 2 illustrates examples of hardware configurations of the client computer 100 and the server computer 200. The client computer 100 includes a CPU 108 and a main memory 110 connected to a bus 109. The CPU 108 is based on 32-bit or 64-bit architecture. For example, Intel Pentium® 4 and AMD Athlon® processors can be used. The bus 109 is connected to a display 114, such as a liquid crystal display (LCD) monitor, through a display controller 112. The display 114 is used for displaying a program such as the web browser 102 as shown in FIG. 1. The bus 109 is also connected to the hard disk 104 and a CD-ROM drive 118 through an Integrated Drive Electronics (IDE) controller 116. The hard disk 104 stores an operating system, the web browser 102, and other programs, which can be loaded into the main memory 110. The CD-ROM drive 118 can download a program from a CD-ROM to the hard disk 104 as needed. Furthermore, the bus 109 is connected to a keyboard 122 or a mouse 124 via a keyboard/mouse controller 120. The keyboard 122 can be used for inputting an URL or other characters on a screen. The mouse 122 can be used to drag-and-drop GUI components or to click on a menu button to start operations.

The communication interface 106 is based on the Ethernet protocol and functions to physically connect the client computer 100 to the communication line 300. The communication interface 106 provides a network interface layer conforming to a TCP/IP communication protocol of a communication function of the operating system of the client computer 100. Incidentally, illustrated components are wired but may be connected through a wireless local area network (LAN) conforming to the wireless LAN connection standards, for example, IEE802.11a/b/g.

Further, the communication interface 106 may conform to an arbitrary protocol such as a token ring in place of the Ethernet protocol. The present embodiments are not limited to a particular physical communication protocol.

The server computer 200 includes a CPU 208 and a main memory 210, which is connected to a bus 209. Similar to the client computer 100, CPU 208 is based on 32-bit or 64-bit architecture. For example, Intel Pentium® 4, Xeon®, and AMD Athlon® processors can be used. The bus 209 is connected to a display 214 such as an LCD monitor through a display controller 212. The display 214 is used to create GUI components connected to the Internet, to write a program in JavaScript and register the program such that the client program 100 can call the registered program, or to register a user ID and password of a user accessing the program through the client program 100 with a system administrator.

The bus 209 is connected to the hard disk 204 and a CD-ROM drive 218 through an IDE controller 216. The hard disk 204 stores an operating system, the web browser 102, and other computer programs, which can be loaded into the main memory 210. The CD-ROM drive 218 can download a program from a CD-ROM to the hard disk 204 as needed. The bus 209 is connected to a keyboard 222 and a mouse 224 through a keyboard mouse controller 220. The keyboard 222 is used to input a URL or other characters on a screen. The mouse 222 is used to create GUI components.

The communication interface 206 conforms to the Ethernet protocol, and functions to physically connect the server computer 200 to the communication line 300. The communication interface 206 provides a network interface layer with respect to a TCP/IP communication protocol implemented in the operating system on the server computer 200. Illustrated components are wired but may be connected through a wireless LAN based on the wireless LAN connection standards, for example, IEE802.11a/b/g.

Further, the communication interface 206 may conform to an arbitrary protocol such as a token ring in place of the Ethernet protocol. The present embodiments are not limited to a particular physical communication protocol.

The hard disk 204 of the server computer 200 also stores a program that provides a development environment in addition to the above operating system and the Web application server 202. The development environment can be obtained by various methods. For example, the development environment can be obtained by combining a module provided by the Dojo Toolkitas a library of JavaScript, and a module written in a JavaScript language in accordance with embodiments described herein. The website http://dojotoolkit.org/ provides some examples and provides additional information. The hard disk 204 of the server computer 200 stores the development environment to allow the client computer 100, when logging on to the server computer 200, to download the development environment with the function of the Web application server 202.

Incidentally, embodiments are not limited to a module written in JavaScript. An embodiment can be accomplished by use of Jscript or VBSCript, known examples of browser assembly languages. Furthermore, it is possible to adopt a configuration that executes a Java program installed in HTML and sends back the execution result to a Web browser.

Additionally, FIGS. 1 and 2 illustrate the client/server configuration, but embodiments can be accomplished with only the configuration of the client computer 100. In this case, the above development environment or module may be directly resident in the client computer 100. Under this condition, the computer directly accesses the Internet through the communication line 300 and the proxy server 400 as shown in FIG. 1.

Furthermore, in FIG. 1, the client computer 100 and the server computer 200 are provided inside a firewall, but the server computer may be provided outside the firewall. In this case, if there is a fear about security, a security level can be improved with several security mechanisms such as VPN.

Further, FIGS. 1 and 2 show the client/server configuration, but the present embodiments can be accomplished with only the configuration of the client computer 100. In this case, the above development environment or module may be directly resident in the client computer 100. Under this condition, the computer directly accesses the Internet through the communication line 300 and the proxy server 400 as shown in FIG. 1.

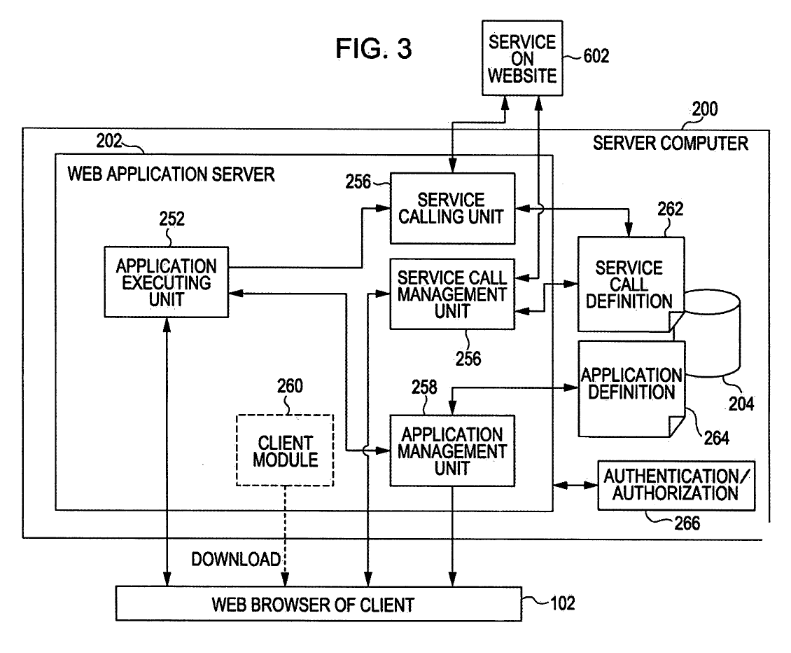

FIG. 3 illustrates an example of the web application server 202 in the server computer 200. In the block diagram of FIG. 2, the hardware components are illustrated concretely to some extent. In this example, a more abstract block diagram of a software module is used. In FIG. 3, the web application server 202 includes an application executing unit 252, a service calling unit 254, a service call management unit 256, and an application management unit 258.

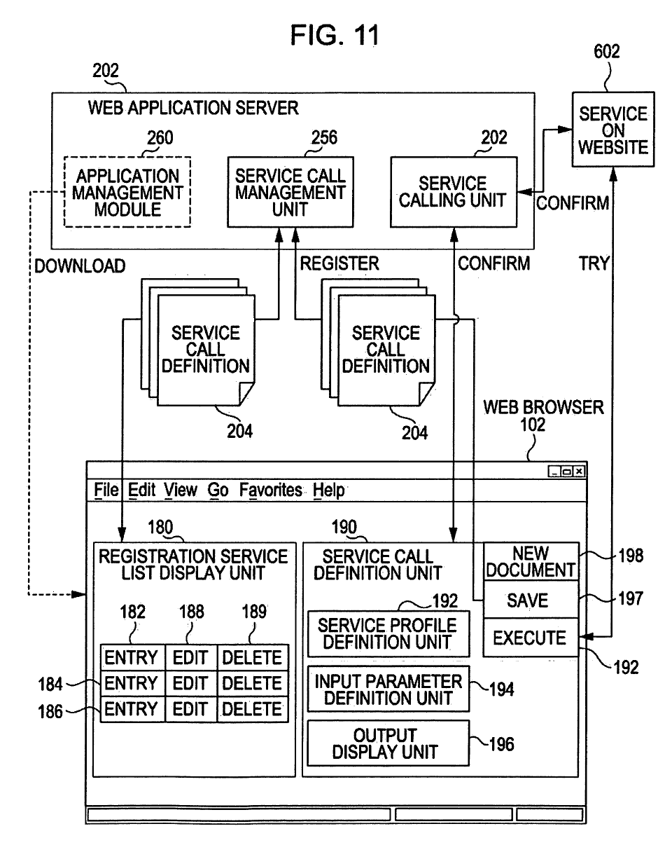

The hard disk 204 records a service call definition 262 and an application definition 264 in a callable manner. The service call definition 262 stores plural service model elements (i.e., often implementing widgets) which access individual Web sites prepared by a predetermined system administrator. FIG. 11 later describes how to create and edit the service model elements. The application definition 264 stores an application program, including a widget and other processing procedures, defined in the service call definition 262 and pre-created by a user of the client computer 100.

According to some embodiments, an authentication/authorization unit 266 uses, for example, a user ID and password of a user of the client computer 100, which are prepared by a system administrator. These pieces of information are stored, for example, in the hard disk 204. If a user of the client computer 100 logs in the server computer 200, the user is required to enter the user ID and corresponding password. The application executing unit 252 interprets and executes a command sent from the web browser 102. The service calling unit 254 defines a URL or parameter. The application executing unit 252 can directly access a web site service 602 by use of the URL or parameter in the service calling unit 254. For example, the URL specified herein refers to http://www.xyz.com/Service/CGI/purchase.cgi. The parameter refers to cost or goods in http://www.xyz.com/Service/CGI/purchase.cgi?&cost=parm1&goods=parm2. The service call management unit 256 calls an application program owned by the client computer 100 from the application definition 264 in response to a request from the web browser 102, and can edit/execute/delete the program. At this time, information about the owner of the application program can be derived from a user ID of the user that logs in the computer.

The client module 260 in the web application server 202 is generally stored in the hard disk 204, and downloaded to the client computer 100 in response to a request from the Web browser 102. In this embodiment, a typical format of the client module 260 is a JavaScript file represented by the extension js. That is, as a description method of JavaScript, there is a direct writing method, for example,

<script type=“text/javascript”>
<!-actual JavaScript code//-->
</script>

and a description method that designates and calls a file name of JavaScript like <script src=“abc.js”type=“text/javascript”></script>

### On the execution side, the method of designating and calling a file name of JavaScript is mainly used.

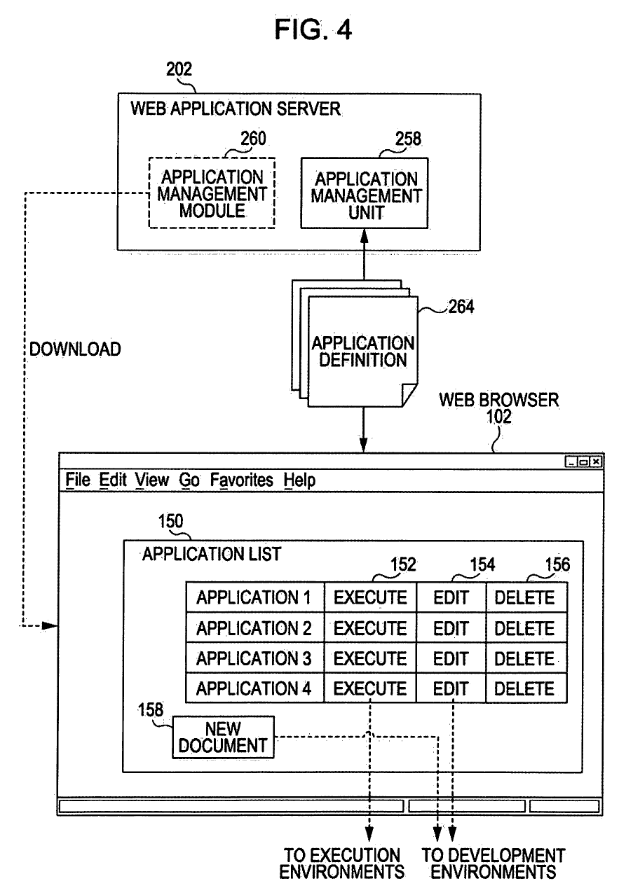

FIG. 4 illustrates an example application management environment of the client computer 100. If a user of the client computer 100 logs in to the server computer 200, the application management module 260 is downloaded to the client computer 100 from the server computer 200 through the processing of the web application server 202. The application management module 260 causes a command, including a user ID of a user that logs in to the computer, to be sent to the application management unit 258. The application management unit 258 subsequently searches the application definition 264 and transmits a name of an application program owned by the user to the client computer 100. As a result, an application list 150 is displayed on a screen of the web browser 102 by virtue of the function of the application management module 260.

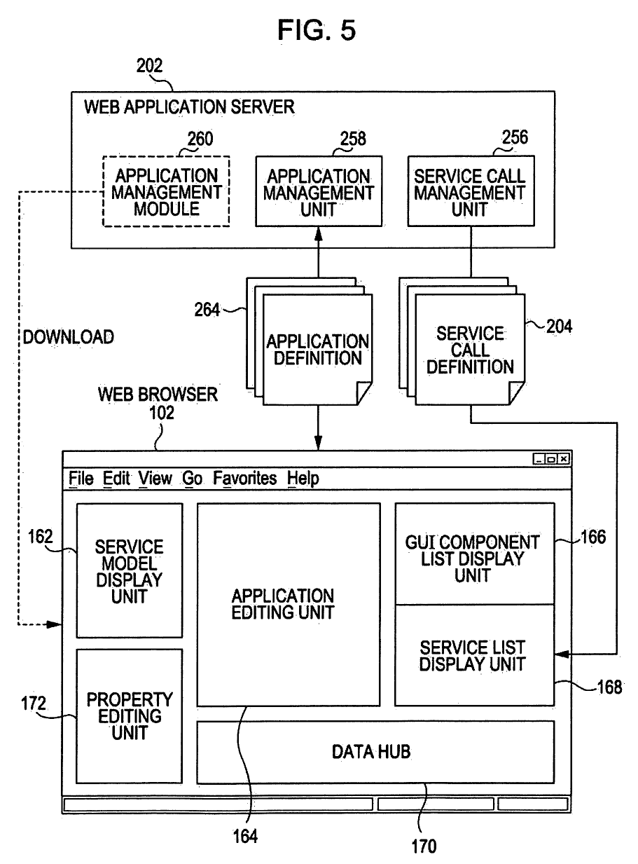

The application list 150 displays Applications 1 to 4 owned by the user, an “Execute” button 152, an “Edit” button 154, and “Delete” button 156, which are arranged on the right side. In response to a click with the mouse 124 (FIG. 2), an execution-environment module is downloaded from the server computer 200 to shift to an execution environment (as described later) of a program on a target line. In response to a click on the button 154 with the mouse 124, a development environment module is downloaded from the server computer 200 to shift to a development environment (FIG. 5) of a program on a target line. In response to a click on the button 156 with the mouse 124, a command to delete a program on the line is sent to the application management unit 258, and accordingly, the application management unit 258 deletes a corresponding application program from the hard disk 204. If a “New Document” button 158 is clicked, a development environment module is downloaded from the server computer 200 to shift to the development environment with the new document.

FIG. 5 illustrates an example execution environment. In FIG. 5, mouse 124 can be used to click the “Edit” button 154 or the “New Document” button 158 on the screen of the web browser 102. Subsequently, the development environment module is downloaded from the application management module 260 to the client computer 100 and displays a screen of FIG. 5 on the Web browser 102. The development environment can be adapted with this operation in some embodiments. The development environment includes plural regions of a service model display unit 162, an application editing unit 164, a GUI component display unit 166, a service list display unit 168, a data hub 170, and a property editing unit 172. In some embodiments, the service model display unit 162 and the GUI component display unit 166 are pallet regions, which can be pasted to the application editing unit 164. The GUI component list display unit 166 displays GUI components such as a button, an edit region, a memo, a label, a component box, and a radio button. The GUI components can be dragged and dropped from the unit 166 to the application editing unit 164. The property editing unit 172 is intended to set or change attributes of a mouse-clicked GUI component or input/output elements of a service such as color, font, display/hide, or enable/disable functionality.

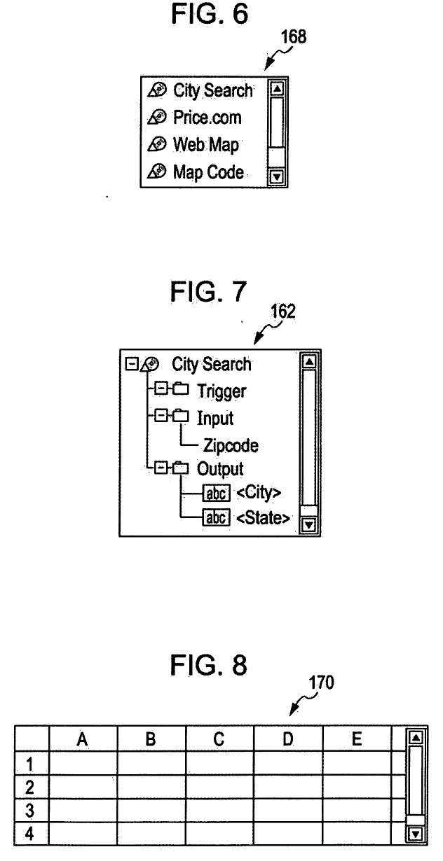

FIG. 6 illustrates how a service list displaying unit 168 lists services for accessing a pre-created web service. In FIG. 6, CitySearch is illustrated as a web site that sends back a state name and a city name if a zip code is input, Price.com as a web site for checking a product price, WebMap as a web site for displaying a map on the site, and MapCode as a web site that sends back the longitude and latitude of a target city or state on the basis of its city or state name.

FIG. 7 illustrates a service model display unit 162, according to an embodiment. The service model display unit 162 illustrates a region where an input element of a service, represented by “Trigger”, and an output element, represented by “Output”, are selected within the service list display unit 168 element and schematically displayed in tree form. The displayed input element and output element can be dragged and dropped to and from the application editing unit 164 or data hub 170, as described below. The application editing unit 164 can be used to drag and drop GUI components from the GUI component list display unit 166, and Trigger elements, input elements, or output elements from the service model display unit 162.

The Trigger element of the service model display unit 162 is pasted to the application editing unit 164 and activated so that a program executes and permits access to a URL designated by the service. The input element of a service displayed on the service model display unit 162 is a parameter supplied at the time of accessing a URL. For example, if an access code is http://www.CitySearch.com/Search/CGI?&zipcode=2428502&coutry=Japan, the zip code is a parameter input element (hereinafter simply referred to as parameter), and 98231 is details thereof. Plural parameters are conceivable like http://www.CitySearch.com/Search/CGI?&zipcode=2428502&coutry=Japan. Thus, the web service does not always include input parameters or elements. A web service having no input element is conceivable. For example, a parameter is unnecessary for a web service that simply sends back data on current Greenwich time.

Alternatively, data transmitted in response to access to a web site can be in various formats, such as HTML, XML, or JSON (JavaScript Object Notation) as a relatively small data exchange format. This allows data sent back in response to access to a web site to be structured data. Thus, as a unit can be dragged and dropped as the output unit of the service model display unit 162, various formats, such as all or a part of the sent XML list, are conceivable.

An asynchronous communication with a service is used to access a web site or web service in an embodiment. This communication is called XMLHttpRequest that is preferably based on Asynchronous JavaScript and XML (Ajax). On the basis of the technique, screen rewriting can be accelerated and a data communication amount can be reduced. Here, a command of a general HTTP protocol may be used.

FIG. 8 illustrates a data hub 170 according to some embodiments. A single cell occupies the data hub 170 if the output element is dragged and dropped to the data hub 170, assuming that the output element is a simple text character string. A conceivable output element of a service, aside from a simple text character string, would be a list structured in XML. If the output element is a list, the number of cells occupying data hub 170 are equal to the number of character strings and numerical values when the output element is dragged and dropped to the data hub 170. Furthermore, character strings or numerical values corresponding to the list are stored in the cells.

The data hub 170, as a data associating region, includes an interface similar to a spreadsheet (also called spreadsheet program), and is divided into sections arranged in matrix format. These sections are referred to as cells and labeled A1, A2, and B1 in accordance with the spreadsheet program. Values are input into each cell or a GUI component pasted to the application editing unit 164 can be dragged and dropped to each cell. Alternatively, a calculation expression in the spreadsheet form like=A1+B1, or =A1&“,”&B1 can be input to each cell. The expression's allowance depends on programming code based on JavaScript or the like. In contrast, each cell can be dragged and dropped to a GUI component pasted to the application editing unit 164 and an input element of a service displayed in the service model display unit 162. Thus, the data hub 170 can utilize the function of JavaScript to provide the above drag-and-drop function and various calculation functions between cells in an embodiment.

As described above, an element output list described in XML may be pasted to the data hub 170 as an output element of a Web service. In this case, if the output element list is dragged and dropped to the data hub 170, as many cells as the number of elements in the list occupy the hub. In this way, it is necessary to compile data on plural cells dragged and dropped from the list. Thus, in this embodiment, statistical functions such as a cumulative function like=SUM(A1 . . . E1), an average function like=AVERAGE(A1 . . . E1), a standard deviation function like=STDEVA(A1 . . . E1), the maximum function like=MAX(A1 . . . E1), and the minimum function like=MIN(A1 . . . E1) are prepared. The JavaScript-based installation with the formula translation is well established as a programming technique and its description is omitted here.

In some embodiments, the drag-and-drop operation is carried out with the Dojo library tool kit as indicated by the following code.

Drag source side: var ds=new dojo.dnd.HtmlDragSource(domNode, dragSourceName);
Drop target side: var dt=new dojo.dnd.HtmlDropTarget(domNode, dropTargetName). Furthermore, information bound through drag-and-drop operations is saved in a declarative format (e.g., XML). A notation example thereof is given below and instructs sourcewidget (a GUI component of a drag-and-drop source) named InputText_{—}0 to be associated with targetwidget (a GUI component of a drag-and-drop target) named Action_{—}0.

<Application:WidgetpropertyBinding sourceWIdget = “inputText_0”
sourcePropertye=“value” sourceEvent=“setValue”
targetWidget=“Action_0”
targetProperty=“value”>
</Application:WidgetPropertyBinding>

Those skilled in the art understand that the application and notation of such a tool kit are given by way of example, and various equivalent techniques can be used. For example, an operating system such as Windows® 2000 and Windows XP® prepare some Application Programming interface (API) functions for drag-and-drop operations such as DragQueryPoint, making it is possible to call an appropriate function and perform processing.

Further, the cell where a user inputs a numerical expression in the data hub 170 is dragged and dropped to an input element and trigger element of a service model displayed in the service model display unit 162 and associated therewith. However, a function of the client development environment of FIG. 5 can be set such that the cell can be directly dragged and dropped to a space of the application editing unit 164, for example, instead of dragging and dropping the cell onto the elements, to thereby automatically paste a GUI component of the text input region thereto and associate a value of the cell of the data hub 170 as a drag-and-drop source therewith. For example, if the cell is dragged and dropped to the space of the application editing unit 164 from the GUI component list display unit 166, the cell is laid on the application editing unit 164 of the selected GUI component by a general technique. Accordingly, it is possible to impart a function to a client development environment by use of a similar technique such that a GUI component representing a text input region is pasted to the drag-and-drop destination in response to a drag-and-drop operation to the space of the application editing unit 164 from the cell of the data hub 170, and the GUI component from the cell of the data hub 170, as the drag-and-drop source, is associated with the text input region.

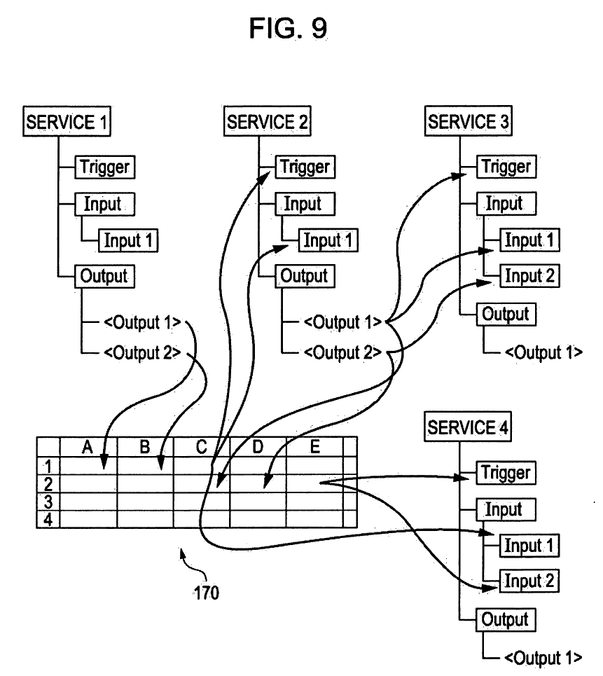

FIG. 9 illustrates how plural web services are associated, according to some embodiments. In FIG. 9, a service 1 has input1 as input and <output1> and <output2> as output. A service 2 has input1 as input and <output1> and <output2> as output. Services 3 and 4 each have input1 and input2 as input and <output1> as output. A method of creating a widget including input and output illustrated in FIGS. 7 and 9 is described below.

A result of computing <output1> and <output2> of the service 1 is sent to input1 of the service 2. In response to the computing result, <output1> and <output2> of the service 2 are directly sent to input1 and input2 of the service 3, and a result of computing <output1> and <output2> of the service 2 is sent to input2 of the service 4. Additionally, a result of computing <output1> and <output2> of the service 1 is sent to input1 of the service 4. Hence, <output1> and <output2> of the service 1 are dragged and dropped to cells A1 and B1 of the data hub 170. A predetermined numerical expression of the cells A1 and B1 is written to a cell C1. The cell C1 is then dragged and dropped to input1 of service 2. Subsequently, <output1> and <output2> of the service 2 are respectively dragged and dropped to cells C2 and D2 of the data hub 170. A predetermined numerical expression of the cells C2 and D2 is written to a cell E2. Then, <output1> and <output2> of the service 2 are directly dragged and dropped to input1 and input2 of the service 3, but not through the data hub 170. Further, the cell C1 of the data hub 170 is dragged and dropped to input1 of the service 4. The cell E2 of the data hub 170 is dragged and dropped to input2 of the service 4. Such a complicated scenario is not practical, but an extreme case is taken to explain an advantage of visual programming with a data hub of an embodiment. If an interface such as the data hub 170 is omitted, a code should be written to realize a program of equivalent functions. In an embodiment, the program of equivalent functions can be realized with skills in using a spreadsheet.

Further, input1 of the service 1 is a field to which information is input with a keyboard or the like. As illustrated in FIG. 9, in response to an action on the “Trigger” button in service 1, a designated web site is accessed and desired information is automatically supplied to the services 2, 3, and 4 through a designated cell of the data hub 170. In FIG. 9, the cell C1 is dragged and dropped to “Trigger” of the service 2 and <output1> of the service 2 is dragged and dropped to “Trigger” of service 3. The cell E2 is dragged and dropped to “Trigger” of the service 4. This causes change in the value of a drag-and-drop source with an event handler named OnChange of JavaScript to automatically start the next service in some embodiments. With the above settings, if data in the cell C1 is changed in accordance with change in data of <output1> and <output2> of the service 1, then the trigger of the service 2, a change in data of <output1> and <output2> of the service 2, the trigger of the service 3, a change of the cell E2, and the trigger of the service 4 are automatically performed in this order.

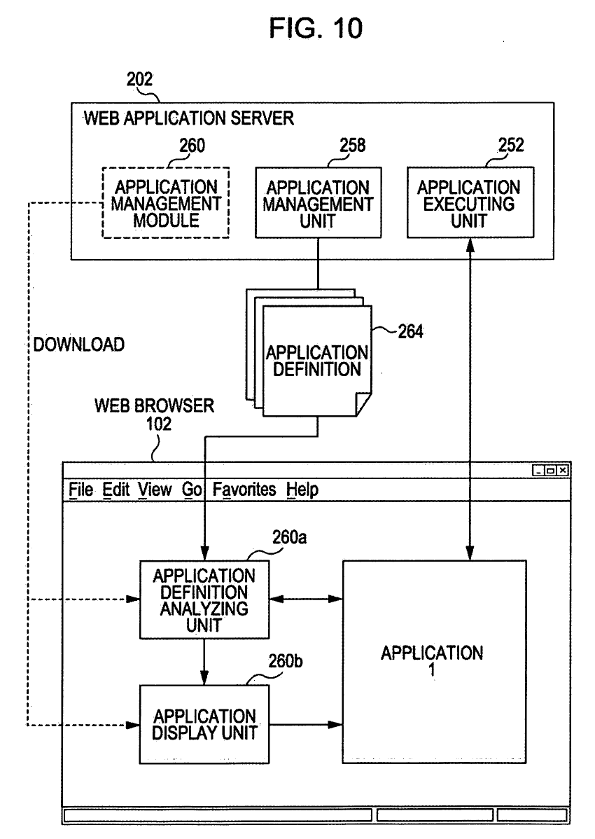

FIG. 10 illustrates an example execution environment of a client, according to some embodiments. Referring back to FIG. 4, an “Execute” button 152 next to the Application 1 is selected. Selection of the button 152 causes a module concerning client execution environments among the application execution modules 260 to be downloaded to the client computer 100. The module concerning client execution environments includes an application definition analyzing unit 260a and an application display unit 260b. “Application 1” in FIG. 4 is selected and the application definition 264 of “application 1” is downloaded from the application management unit 258. The application definition 264 is executed with the application definition analyzing unit 260a. On the basis of the execution result from the application definition analyzing unit 260a, the selected application 1 is displayed on the screen of the Web browser 102 due to the function of the application display unit 260b. Displayed contents are updated in accordance with the execution.

The client computer 106 of FIGS. 1 and 2 can directly access the web sites 602 to 606 via the proxy server 400, but not through the server computer 200. However, there is a fear that a so-called cross site security hole may occur if the server computer 200 accesses an external web site with the downloaded module instead of through the server computer 200. However, as shown in FIG. 10, an application executed by the module downloaded from the web application server 202 accesses an external web site through the application executing unit 252 in the Web application server 202.

FIG. 11 illustrates an example service call management environment, according to some embodiments. The term “service” means a web site that provides a service as indicated by CitySearch or Price.com in FIG. 8. If a user logs in a site through the service call management environment login screen (not shown) based on a predetermined user ID and password, the application management module 260 is downloaded from the web application server 202. As shown in FIG. 11, a menu including a registration service list display unit 180 and a service call definition unit 190 is displayed on the screen of the web browser 102. Thus, an authority to log in the service call management environment is more limited than an authority to log in the application management environment of FIG. 4. In general, only a system administrator is authorized because a created widget of a service appears in the service list display unit 168 on the development screen of FIG. 5 and can be used by any user.

Additionally, registered services are listed on the registration service list display unit 180 based on the service call definition 204 read from the server service call management unit 256 of the web application server 202. In practice, a name of the registered service (for example, CitySearch of FIG. 8) is displayed on entries 182, 184, and 186. The “Edit” button 188 is clicked to display a menu for editing services (not shown). Alternatively, the “Delete” button 189 is selected to thereby delete the service from the service call definition 204. Regarding each of the registered services, a URL (for example, http://www.CitySearch.com/Search/CGI) and a name (for example, CitySearch) of a service determined by a system administrator are registered in a service profile definition unit 192.

In an input parameter definition unit 194, an input parameter name and name and attributes of output data are registered for each of the registered services in the input parameter definition unit 194. For example, if the name is CitySearch, the input parameter name is zip code, and the name and attribute of output data are <City> and <State>, and a text, respectively.

If a system administrator designates a URL, inputs an appropriate parameter, and clicks an “Execute” button 195, the service on website 602 is accessed through the service calling unit 203 of the web application server 202. The execution result is subsequently displayed on the output display unit 196. HTML, XML, and JASON are possible attributes of output data aside from the text in accordance with properties of the web service. The output XML data is a structured document, so the whole data can be listed or data in a specific tag can be retrieved. Accordingly, a system administrator, which creates a widget of a service, appropriately prepares a view for listing the entire output XML data or a view for displaying data in the specific tag. The created view is read from the input parameter definition unit 194 and displayed in the service model displaying unit 162 as indicated by <City> and <State> in FIG. 7 in accordance with the selected service.

If satisfied with the displayed result after clicking the “Execute” button 195, a system administrator clicks the “Save” button 197. Based on the used parameter and information of the output view, the definition of the parameter is stored in the input parameter definition unit 194 in association with the service.

When a system administrator clicks the “New Document” button 198, a screen with a blank URL field and a blank parameter field (not shown) appears. Subsequently, the system administrator inputs an appropriate URL or various parameters, and clicks the “Execute” button 195. If pleased with the result, the system administrator clicks the “Save” button 197. A new URL and name are then stored in the service call definition unit 190, and parameters associated therewith are stored in the input parameter definition unit 194. This results in the creating and storing of a new service call definition 204.

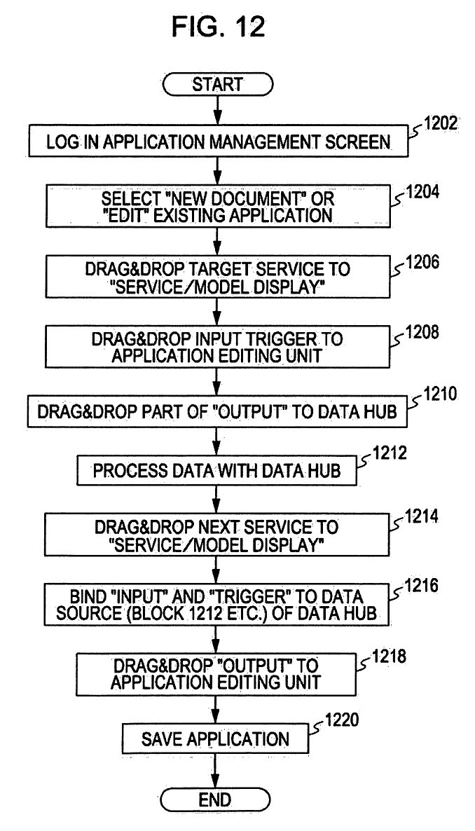

FIG. 12 is a flow diagram illustrating an application development scenario, according to some embodiments. In FIG. 12, a user of the client computer 100 opens the Web browser 102 and logs in the application in block 1202. Next, communications with the web application server 202 are established through the network 300 of FIG. 1, and the application management unit 258 of FIG. 3 displays a log-in screen (not shown) in response. If a user enters a user ID and a password in response thereto, the application management unit 258 references the authentication/authorization module 266 (FIG. 3) to check and authenticate the user ID and password.

Following authentication, the menu of the application management environment of FIG. 4 is displayed in the web browser 102. At block 1204 a new document is selected with “New Document” button 158 or an existing document is edited by selecting the “edit” button 154 from the application list 150. The client development environment module is then loaded to the client computer 100 via the application management unit 258. After initialization, a screen similar to that of FIG. 5 is displayed on the web browser 102. If a new document is created, the application editing unit 164 is blank. If an existing document is edited, the application definition 264 of a selected application is read from the application management unit 258. Afterward, an existing widget, or a similar component, is drawn in the application editing unit 164. The GUI component list 164 lists registered data regardless of whether the clicked button is the “New Document” button or “Save” button. The service call management unit 256 then calls the registered service call definition 204 and adds a service model to a list of the service list calling unit 168 in accordance with a name of the service defined in the definition 204.

At block 1206, a user can drag-and-drop an intended service model (simply referred to as “service”) to the service model display unit 162 by utilizing a mouse. Next, elements of the selected service are displayed on the service model displaying unit 162 with the structure defined in the input parameter definition unit 194, as shown in FIG. 11 and in the FIG. 7 example.

At block 1208, a user can drag-and-drop “Input” and “Trigger” to the application editing unit 164. At block 1210, the user drags and drops “Output” intended as “Input” of another service model to an arbitrary cell of the data hub 170.

At block 1212, the service list display unit 168 supplies an output reference of the service model as the drag-and-drop source in response to the drag-and-drop operation. On the other hand, on the data hub 170 side, a bind of source data to a cell as a drag-and-drop target is created in the application definition memory (although not shown, allocated to the main memory 110 of FIG. 2). A calculation expression is input into a cell near the cell as the drag-and-drop target. The calculation is then executed based on a value stored in the application definition memory. The result thereof is displayed in reflection of the cell where the expression is input.

At block 1214, the user drags and drops the next user model to the service model display unit 162. Then, the structure of the dragged and dropped service model such as input and output is displayed on the service model display unit 162 due to the same function as that in block 1206.

At block 1216, a user drags and drops the cell having the expression input therein on the data hub 170 side to input and trigger displayed on the service model display unit 162 to thereby bind these. Then, the service model display unit 162 supplies a reference to input and trigger where the cell is dragged and dropped. On the other hand, the data hub 170 creates bind between input reference and cell reference and bind between trigger reference and cell reference in the application definition memory.

At block 1218, output of the service model display unit 162 is dragged and dropped to the application editing unit 164 (see FIG. 5). In response, the application editing unit 164 creates a reference of output from the service model display unit 162 and displays the reference on the drag-and-drop destination.

At block 1220, although not shown in FIG. 5, a predetermined button or the like selects the option to save a created application and the application development environment module subsequently transmits data in the application definition memory to the application management unit 258 (see FIG. 3). The application management unit 258 then stores the data to the hard disk 204 such that the data can be read later.

In the case of calling and executing the saved application, a user logs in the application and selects a menu for displaying an application management environment. A corresponding application management module is then downloaded to the client computer 100 through the operation of the web server application program 202. Finally, a screen similar to that of FIG. 4 is displayed.

Here, a user selects a predetermined application and clicks a corresponding “Execute” button 162 and then a module for executing an application is downloaded to the client computer 100 through the operation of the web server application program 202 and executed. This operation is described above with reference to FIG. 10.

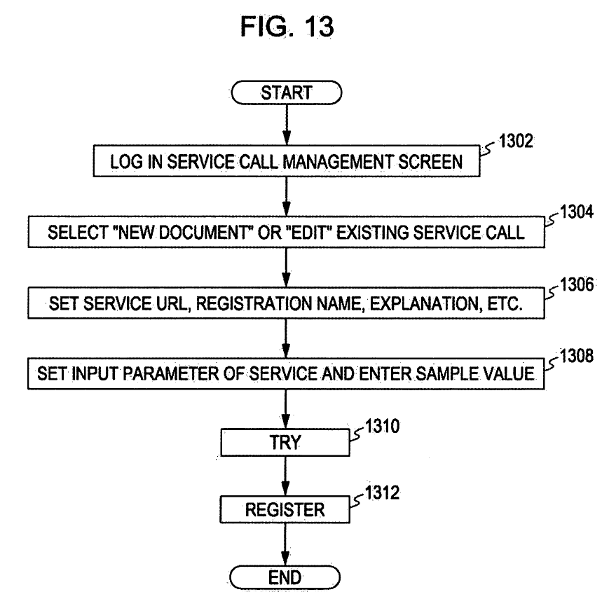

In FIG. 13, a user of the client computer 100 opens the web browser 102 and logs in the service call management menu in block 1302. Communications with the web application server 202 are then established through the network 300 of FIG. 1 and the application management unit 258 sends back a log in screen (not shown). In response, a user enters a user ID and a password and then, the application management unit 258 references the authentication/authorization module 266 (see FIG. 3) to check and authenticate the user ID and the password. In general, an authority to log in the service call management menu is limited more rigidly than an authority to the application development screen of FIG. 12. This is because the registered service model is commonly selected by users and thus needs to operate with reliability and it is desirable to create the model with a skilled person.

After the user logs in the menu, a predetermined module 260 is downloaded to the client computer 100 from the web application server 202, and a menu of FIG. 11 is displayed on the screen of the web browser 102. Subsequently, in block 1302, entries 182, 184, and 186 are displayed on the registered service list display unit.

In the case of creating a new document, a user clicks a button 199 (see FIG. 11). The user enters a service URL, a registration name, and interpretation in block 1306. Furthermore, the user sets input parameters of a service and inputs parameter values in block 1308.

In the case of editing an existing document, a user clicks an “Edit” button 189 of a corresponding entry (see FIG. 11). Subsequently, a corresponding service call definition 262 is downloaded from the service call management unit 256 and data is thereby supplied to the service profile definition unit 192 and the input parameter definition unit 194.

At block 1310, a user selects the button 197 to attempt to log in a target website. This operation is executed in such a way that the service call definition unit 190 makes an HTTP request to access the service on website 602 through the service calling unit 203. In particular, the made HTTP request is GET in some embodiments, and the service call definition unit 190 can directly send the request to the service on website 602.

In this way, the service call definition unit 190 receives the result from the service 602 of a web site and displays the result on the output display unit 196. If satisfied with the result, a user clicks the “Save” button 198 (see FIG. 11) in block 1312. The service call definition unit 190 then constructs the service call definition 262 based on data displayed on the output display unit 196 and sends the definition to the service call management unit 256 of the Web application server 202. Subsequently, the service call management unit 256 saves the sent service call management unit 256 in the hard disk 204.

Next, application development operations of some embodiments are explained with concrete descriptions. It is assumed that to create such an application, a user enters (1) zip code to a web site named CitySearch to acquire data about a city and data about a state, (2) and accesses a web site named MapCode by combining the data about the city and the data about the state to obtain (3) the latitude and longitude of the city. Incidentally, CitySearch sends back data about a city and data about a state independently, but MapCode requires a combined one of the data about the city and the data about the state.

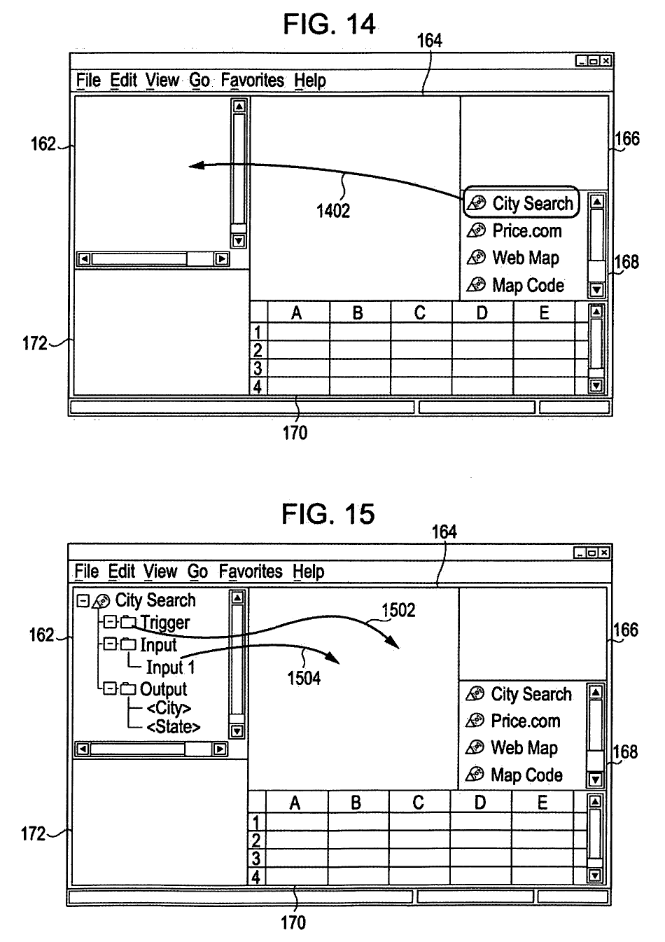

FIG. 14 illustrates an initial screen of new application development according to some embodiments. In this screen, the GUI component list display unit 166 and the property editing unit 172 are not shown because they are not related to the following description. A user drags and drops CitySearch from the service list display unit 168 to the service model display unit 162 on this screen as indicated by the arrow 1402.

FIG. 15 illustrates the structure, including input and output, of CitySearch as displayed in the service model display unit 162. This structure is created by a system administrator in accordance with CitySearch, and the definition thereof has been stored in the service call definition 262 as shown in FIG. 11. In FIG. 15, “trigger” of CitySearch is dragged and dropped to the application editing unit 164 from the service model display unit 162 as indicated by the arrow 1502. Furthermore, “input1” of CitySearch is dragged and dropped to the application editing unit 164 as indicated by the arrow 1504.

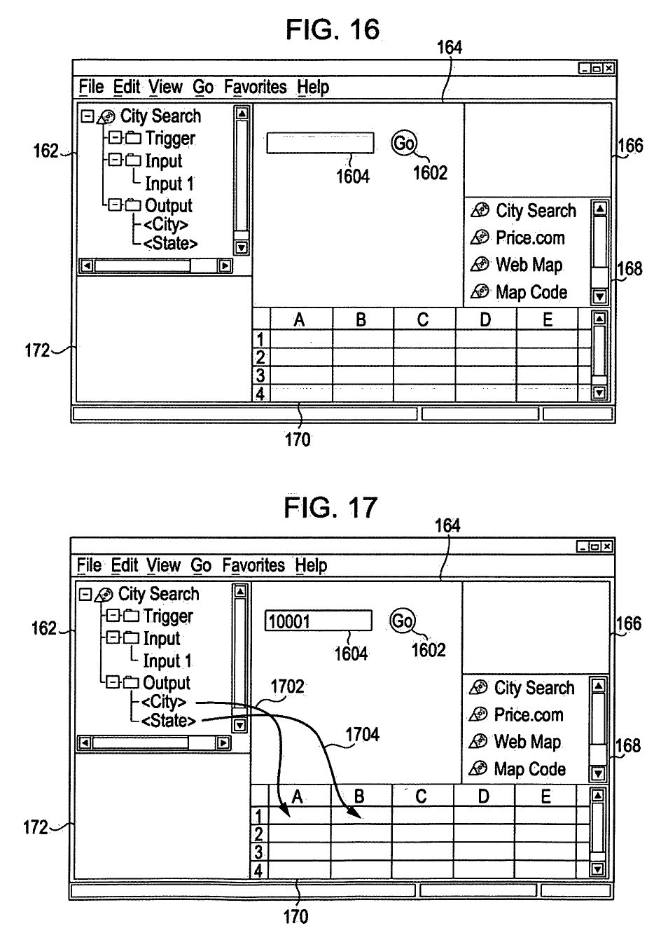

FIG. 16 illustrates the operation of a region where “trigger” is dragged and dropped becoming a button 1602. This button can include a character “Go”. Furthermore, a region where “input1” is dragged and dropped becomes a text input field 1604.

FIG. 17 illustrates the outcome of the aforementioned operations. If zip code of “10001” is input to the text input field 1604 and the button 1602 is clicked, an access to CitySearch is made through the service call management unit 256 of FIG. 3 with the parameter of zip code=“10001”, and CitySearch sends back “New York” and “NY” to <City> and <State>, respectively. In some embodiments, a user drags and drops <City> from the “Output” folder of CitySearch displayed on the service model display unit 162 to a cell A1 of the data hub 170 as indicated by the arrow 1702. As indicated by the arrow 1704, the user drags and drops <State> from the “Output” folder to a cell B1 of the data hub 170.

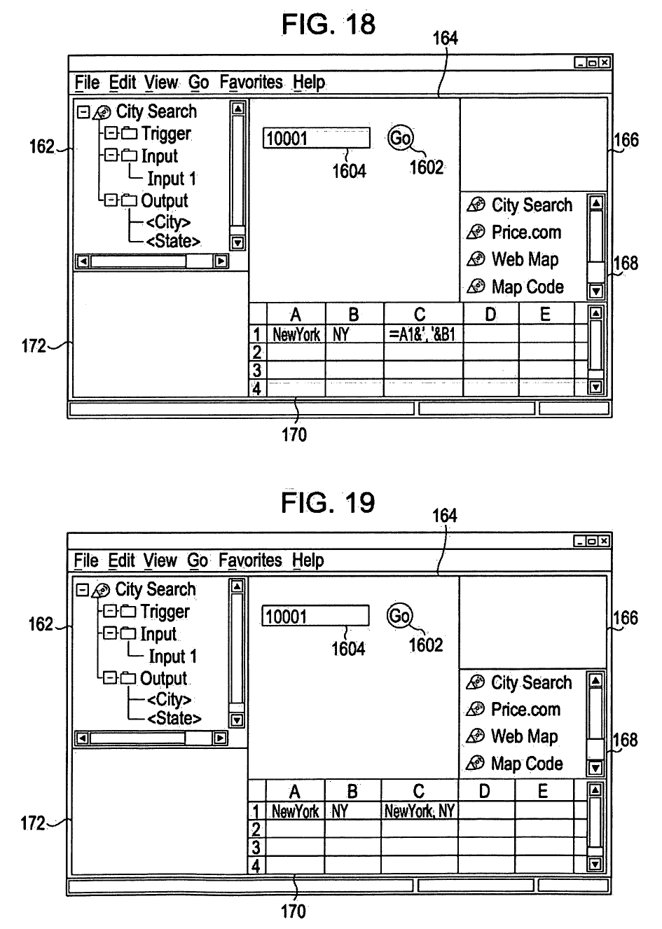

FIG. 18 illustrates how the cell A1 and the cell B1 are bound to <City> and <State>, respectively. In FIG. 18, ‘New York’ and ‘NY’ are displayed in the cell A1 and cell B1 of the data hub 170, respectively. A user then enters=A1&‘,’&B1 to cell C1 of the data hub 170 with a character string binding operator & and presses the “End of Line” key.

FIG. 19 illustrates the solved calculation expression and ‘New York, N.Y.’ is displayed in the cell C1. Incidentally, in some embodiments, as for restrictions of the operator, the operator is coated in JavaScript such that a general format is realized in a general spreadsheet program. However, general notation can be realized with another programming language such as =A1+‘,’+B2. Further, those skilled in the art would readily understand that arbitrary computation, such as addition, subtraction, or other mathematical functions, can be realized aside from computation with the string character binding operator. Furthermore, in this example, output from the web service is stored in both of the cells A1 and B1. However, various applications are conceivable. For example, a character string directly input to a cell by a user or a calculation expression including a reference to the other cell may be entered to one cell.

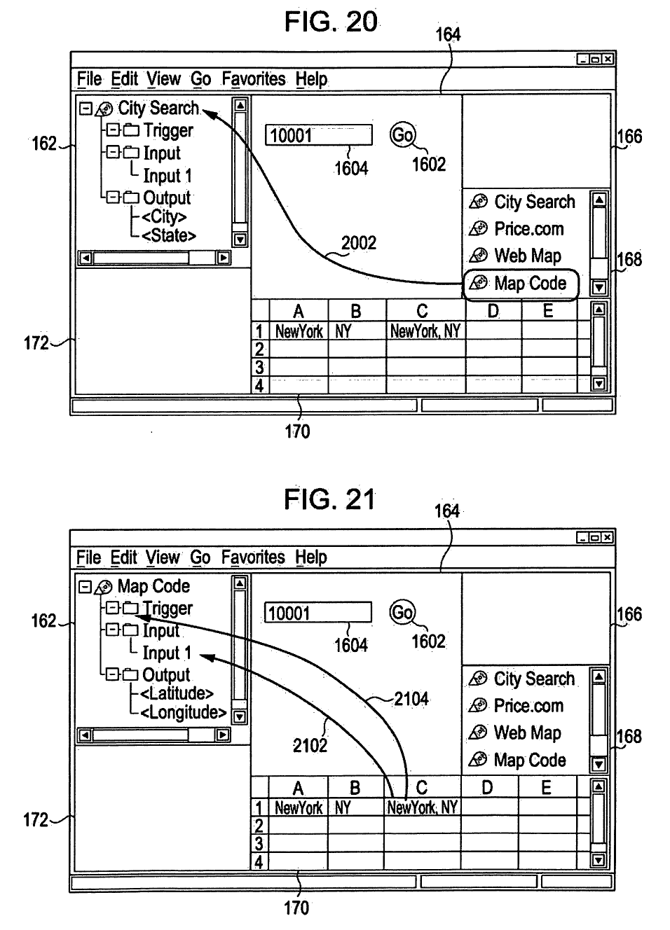

FIG. 20 illustrates the operation of MapCode being dragged and dropped to an arbitrary region of the service model display unit 162 from the service list display unit 168, as indicated by the arrow 2002, according to some embodiments.

FIG. 21 illustrates the structure, including input and output, of MapCode as displayed on the service model display unit 162, according to some embodiments. The definition of the structure has been created in accordance with MapCode and stored in the service call definition 262 by a system administrator. A user then drags and drops the cell C1 of the data hub 170 to “Trigger” and “Input1” of MapCode in the service model display unit 162, as indicated by the arrows 2102 and 2104 on the screen of FIG. 21. The reason the cell is dragged and dropped to not only “Input1”, but also “Trigger”, is to automatically respond to change in value of the cell C1 of the data hub 170 and access MapCode with “Input1” used as a parameter.

Incidentally, instead of directly dragging and dropping the cell C1 to “Input1” of MapCode displayed in the service display unit 168, “Input1” of MapCode may be temporarily dragged and dropped to the application editing unit 164. The cell C1 may then be dragged and dropped to the drag-and-drop target in the application editing unit 164. This situation is not different from the above situation in that a value of the cell C1 is supplied to “Input1” of MapCode. This setting helps a user in visually observing the value supplied to “Input1” of MapCode as an intermediate step on the screen when an application is later executed.

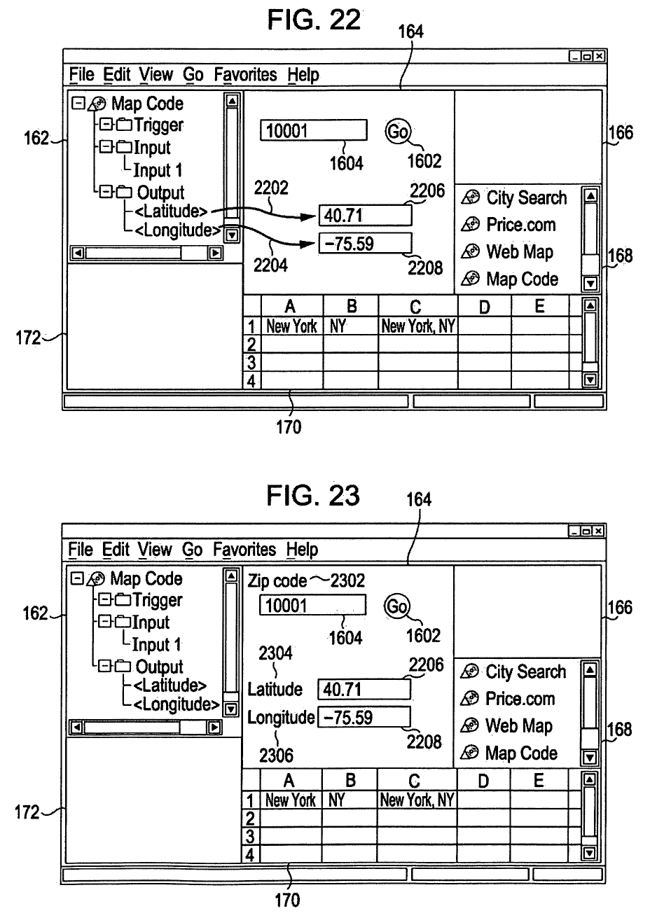

FIG. 22 illustrates a display of the results of the above operations, according to some embodiments. In practice, as “Trigger” of MapCode is changed from an unassociated state to an associated state in response to the drag-and-drop operation, MapCode is accessed with the parameter of New York, N.Y., and MapCode sends back the latitude and longitude of New York with <latitude>=40.71 and <longitude>=−75.59. Then, <latitude> and <longitude> from the “Output” folder of MapCode are dragged and dropped from the service model display unit 162 to the application editing unit 164 as indicated by the arrows 2202 and 2204. They subsequently display these values on the application editing unit 164.

FIG. 23 illustrates how a user appropriately adds character strings 2302, 2304, 2306 for facilitating understanding of the application to save the application according to some embodiments. The saved application can be selected and executed in the procedure illustrated in FIG. 4.

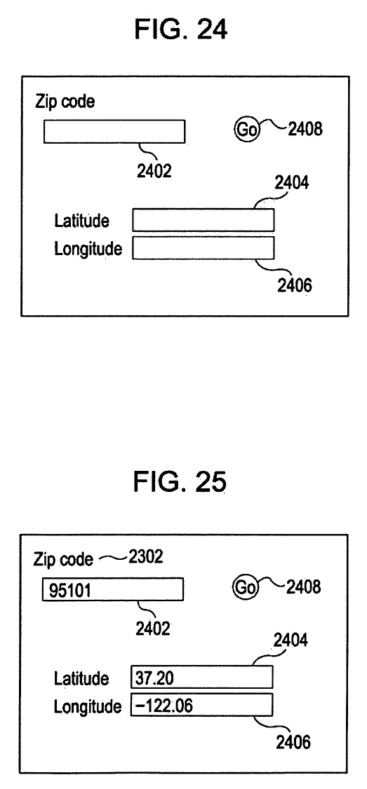

FIG. 24 illustrates the execution screen according to some embodiments. Information about calculated data realized through the data hub 170 is preferably described in the application definition 264 as internal data expressed in XML. A user enters, for example, “95101” in zip code and clicks a “Go” button 2408. Then, although hidden from the eyes of the user, an access to CitySearch is made with the parameter of zip code=“95101”. CitySearch transmits <City>=‘San Jose’ and <State>=‘CA’. The system changes a defined memory variable to ‘San Jose, Calif.’ in accordance with internal definition created and saved with the procedure illustrated in FIGS. 14 to 23. MapCode is then triggered in response to the change and accessed with the parameter of ‘San Jose, Calif.’, and then sends back 37.20 and −122.06 to <latitude> and <longitude>, respectively.

FIG. 25 illustrates the results of the above operations.

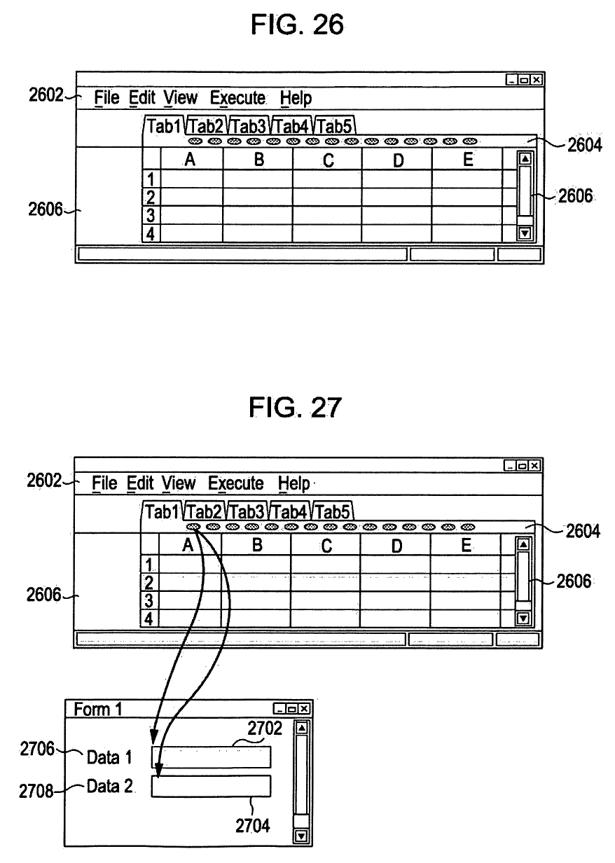

FIG. 26 illustrates a screen interface familiar in an existing visual creating tool according to some embodiments. In this interface, a menu bar 2602 includes a menu such as “File”, “Edit”, or “View”. Particularly, “File” includes a submenu such as “New Document”, “Save As”, “Save”, or “End”. A program on the display screen is read from the hard disk 104 of FIG. 2 to the main memory 110 as a result of the CPU 108 operations and the operating system. The program is subsequently displayed on the display 114.

In the GUI component pallet region 2604, existing GUI components, such as a text input region, a label, a memo, and a combo box, are arranged in a form such that the components can be dragged and dropped. The GUI component pallet region 2604 is preferably classified by kind with a tab, such as Tab1, Tab2, Tab3, Tab4, and Tab 5. A user selects a tab including a GUI component to paste. Furthermore, a property editing unit 2606 for editing other attributes, such as a color and font, of the GUI component that are pasted to the form is presented. These components are provided by an existing application development tool, but a novel function in some embodiments is a function of the data hub 2606 that looks like a spreadsheet. This function is substantially equivalent to that of the data hub 170 of FIG. 5.

FIG. 27 illustrates how a window is created from the above operations, according to some embodiments. A user first selects “New Document” from “File” of the menu bar. Then, as shown in FIG. 27, a window Of “Form1” is created. If a user drags and drops components in the text input region from the GUI component pallet region 2604 to Form1, the text input regions 2702 and 2704 are displayed. Furthermore, a label is dragged and dropped as needed, and characters 2706 and 2708 are added as needed.

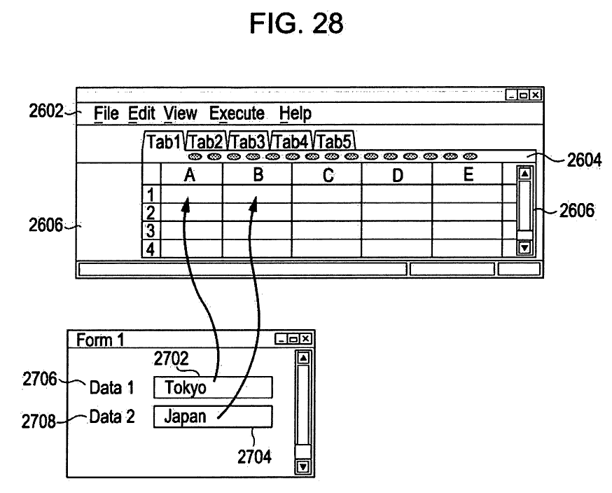

FIG. 28 illustrates how data is input into the above created window, according to some embodiments. In FIG. 28, the word ‘Tokyo’ is input to the text input region 2702, and the word ‘Japan’ is input to the text input region 2704. Thus, the cells A1 and B1 of the data hub 2606 are dragged and dropped.

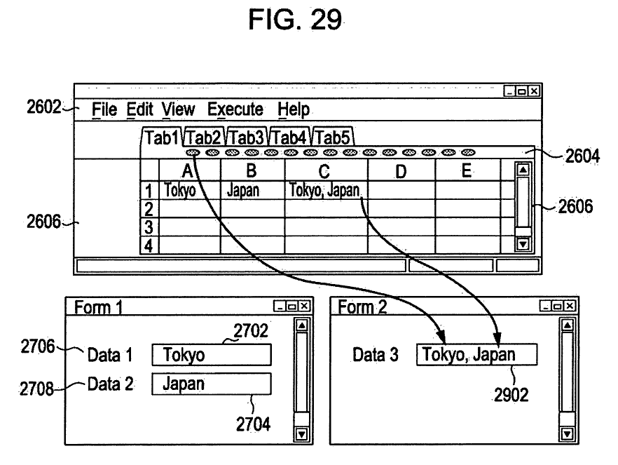

FIG. 29 illustrates a display window resulting from the above operations, according to some embodiments. As shown in FIG. 29, ‘Tokyo’ and ‘Japan’ are displayed in the cells A1 and B1 of the data hub 2606. If an expression=A1&‘,’&B1 is input to cell C1 and an end-of-line key is pressed, data of ‘Tokyo, Japan’ is displayed in C1. A user then selects “New Document” of a form from “File” in the menu bar. Subsequently, as shown in FIG. 29, a window “Form2” is created. If a component of the text input region is dropped from the GUI component pallet 2604 to Form2, the text input region 2902 is displayed. If the cell C1 of the data hub 2606 is dragged and dropped to the text input region 2902, ‘Tokyo, Japan’ is displayed in the text input region 2902.

Regions in the same or different forms are associated through the data hub. The relationship between fields can be automatically described in one source code in the same project. Furthermore, an event of a change in value on an association source side may be trapped and automatically reflected to an association target within the limitation of existing techniques.

If the visual tool relates to BASIC, C++, C#, and Java, it is likely that a user needs to describe a code. However, a concept of a data hub would facilitate association between different regions and improve efficiency in creating a code.

Embodiments are not limited to a particular method and system, but also encompass a program stored in a computer readable medium, such as CD-ROM, DVD-R, or HDD, or a program downloadable from a web site. Some embodiments construct the above system in corporation with a computer hardware component.

Furthermore, this embodiment is described based on a computer language such as JavaScript, BASIC, C++, C#, or Java. Embodiments are not limited to a particular computer language and environment. If the above GUI environment is obtained, any system or method, or any computer program for realizing the system or method, is within the scope of an embodiment.

In the above embodiment, the data hub region is designed to look like a spreadsheet and include an interface. Such a display form is not essential to an embodiment. The data hub region may include any other display interfaces provided that plural fields that can be dragged and dropped and plural fields that can store a calculated value based on a function stored in the fields are provided.

The described embodiments may be provided as a computer program product, or software, that may include a machine-readable medium having stored thereon instructions, which may be used to program a computer system (or other electronic device(s)) to perform a process according to embodiments, whether presently described or not, since every conceivable variation is not enumerated herein. A machine readable medium includes any mechanism for storing or transmitting information in a form (e.g., software, processing application) readable by a machine (e.g., a computer). The machine-readable medium may include, but is not limited to, magnetic storage medium (e.g., floppy diskette); optical storage medium (e.g., CD-ROM); magneto-optical storage medium; read only memory (ROM); random access memory (RAM); erasable programmable memory (e.g., EPROM and EEPROM); flash memory; or other types of medium suitable for storing electronic instructions. In addition, embodiments may be embodied in an electrical, optical, acoustical or other form of propagated signal (e.g., carrier waves, infrared signals, digital signals, etc.), or wireline, wireless, or other communications medium.

Plural instances may be provided for components, operations or structures described herein as a single instance. Finally, boundaries between various components, operations and data stores are somewhat arbitrary, and particular operations are illustrated in the context of specific illustrative configurations. Other allocations of functionality are envisioned and may fall within the scope of the embodiment(s). In general, structures and functionality presented as separate components in the exemplary configurations may be implemented as a combined structure or component. Similarly, structures and functionality presented as a single component may be implemented as separate components. These and other variations, modifications, additions, and improvements may fall within the scope of the embodiment(s).

What is claimed is:

1. A method comprising:
presenting a graphical user interface for a web page application development tool that aggregates web services;
displaying a set of web service indicators in a first region of the graphical user interface, a set of web page controls in a second region of the graphical user interface, and input, output, and trigger elements that correspond to web services represented by the set of web service indicators in a third region;
associating a first of the set of input elements, a first of the set of output elements, and a first of the set of trigger elements in a fourth region, the first trigger element pre-defined with a first code unit executable to perform a first set of one or more operations of a first web service represented by a first one of the set of web service indicators, the first set of one or more operations performed on input received by the first input element to produce output for the first output element;
associating in the fourth region a second one of the input elements and a second one of the trigger elements that is pre-defined with a second unit of code executable to perform a second set of one or more operations on input received by the second input element to produce output for a second one of the output elements, the second input element, the second output element, and the second trigger element corresponding to a second web service represented by a second one of the set of web service indicators;
associating the second input element with the first output element; and
generating a web page application based, at least in part, on the elements associated in the fourth region.

2. The method of claim 1, further comprising:
displaying a plurality of cells in a fifth region, a first of the plurality of cells having a function;
applying the function to output of the first output element.

3. The method of claim 2, wherein said associating the first output element with the second input element comprises associating a result of the function being applied to the output of the first output element to the second input element.

4. The method of claim 3, wherein a second of the plurality of cells in the fifth region displays the output of the first output element, and the first cell displays the result of the function.

5. The method of claim 1 further comprising downloading a plurality of service call definitions from over a network, wherein the plurality of service call definitions include the first and the second code units.

6. The method of claim 1 further comprising displaying the first input element, the first output element, and the first trigger element in the fourth region in response to the first web service indicator being dragged and dropped from the first region.

7. The method of claim 1, wherein the graphical user interface is presented in a web browser.

8. One or more machine-readable media having instructions encoded therein, which when executed by a set of one or more processing units causes the set of one or more processing units to perform operations that comprise:
presenting a graphical user interface for a web page application development tool that aggregates web services;
displaying a set of web service indicators in a first region of the graphical user interface, a set of web page controls in a second region of the graphical user interface, and input, output, and trigger elements that correspond to web services represented by the set of web service indicators in a third region;
associating a first of the set of input elements, a first of the set of output elements, and a first of the set of trigger elements in a fourth region, the first trigger element pre-defined with a first code unit executable to perform a first set of one or more operations of a first web service represented by a first one of the set of web service indicators, the first set of one or more operations performed on input received by the first input element to produce output for the first output element;
associating in the fourth region a second one of the input elements and a second one of the trigger elements that is pre-defined with a second unit of code executable to perform a second set of one or more operations on input received by the second input element to produce output for a second one of the output elements, the second input element, the second output element, and the second trigger element corresponding to a second web service represented by a second one of the set of web service indicators;
associating the second input element with the first output element; and
generating a web page application based, at least in part, on the elements associated in the fourth region.

9. The machine-readable media of claim 8, wherein the operations further comprise:
displaying a plurality of cells in a fifth region, a first of the plurality of cells having a function; and
applying the function to output of the first output element.

10. The machine-readable media of claim 9, wherein associating the first output element to the second input element comprises associating a result of the function to the second input element.

11. The machine-readable media of claim 10, wherein the operations further comprise displaying the output of the first output element in a second of the plurality of cells in the fourth region, and displaying the result in the first cell.

12. The machine-readable media of claim 8, wherein the operations further comprise retrieving a plurality of service call definitions from over a network, wherein the plurality of service call definitions include the first and the second code units.

13. The machine-readable media of claim 8, wherein the operations further comprise displaying the first input element, the first output element, and the first trigger element in the third region in response to a drag and drop operation of the first web service indicator from the first region.

14. The machine-readable media of claim 8, wherein the graphical user interface is presented in a web browser.

15. A computer-assisted application program creating system comprising:
a display unit operable to display a graphical user interface for creating a web application that accesses a set of one or more web services;
a web service display unit configured to display a list of indicators of web services;
a service model display unit configured to display input, trigger, and output elements of a web service represented by an indicator in the list of indicators of web services;
an application editing unit configured to associate input, output and trigger elements of different web services represented by indicators in the list of indicators of web services; and
a data hub configured to display output of a first output element that corresponds to a first of the different web services and configured to apply a function to the output.

16. The system of claim 15 further comprising a graphical user interface component list display unit to display a palette of web page controls.

17. The system of claim 15, wherein the web page controls comprise a radio button, a checkbox, a box, and a text editing box.

18. An apparatus comprising:
a service list display unit operable to display a set of web service indicators in a first region of a graphical user interface,
a graphical user interface component list display unit operable to display a palette of web page controls in a second region of the graphical user interface;
a service model display unit operable to display input, output, and trigger elements that correspond to web services represented by the set of web service indicators in a third region of the graphical user interface; and
an application editing unit operable to associate,
a first of the set of input elements, a first of the set of output elements, and a first of the set of trigger elements in a fourth region, the first trigger element pre-defined with a first code unit executable to perform a first set of one or more operations of a first web service represented by a first one of the set of web service indicators, the first set of one or more operations performed on input received by the first input element to produce output for the first output element;
in the fourth region, a second one of the input elements and a second one of the trigger elements that is pre-defined with a second unit of code executable to perform a second set of one or more operations on input received by the second input element to produce output for a second one of the output elements, the second input element, the second output element, and the second trigger element corresponding to a second web service represented by a second one of the set of web service indicators;
the second input element with the first output element, and
operable to generate a web page application based, at least in part, on the elements associated in the fourth region.

19. The apparatus of claim 18 further comprising a data hub operable to display a plurality of cells in a fifth region, a first of the plurality of cells having a function, and operable to apply the function to output of the first output element.

20. The apparatus of claim 19, wherein the application editing unit being operable to associate the first output element with the second input element comprises the application editing unit being operable to associate a result of the function being applied to the output of the first output element to the second input element.
